(19) United States
(12) Patent Application Publication
(10) Pub. No.: US 2007/0290039 A1
(43) Pub. Date: Dec. 20, 2007

(54) Method and apparatus for in vehicle low price fuel finder

(75) Inventors: Gerald W. Pfleging, Batavia, IL (US); George Wilkin, Bolingbrook, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/471,692

(22) Filed: Jun. 20, 2006

(51) Int. Cl. G07B 15/02; G06F 17/00

(52) U.S. Cl. 235/384; 235/375

(57) ABSTRACT

A method for recommending service stations for vehicles based on a users route or location is disclosed. The method comprises mapping a user's current location, collecting fuel prices from stations that are within a predetermined distance from the user's location and displaying the location of at least one service station, based at least in part on fuel prices. The method also could include mapping the user's route and collecting fuel prices from a second set of stations that are within the user's route and displaying the location of the stations based on the fuel prices. This method may be linked to a vehicle navigation system which in turn may track the amount of fuel left in the vehicle and recommend service stations when the amount of fuel remaining in the vehicle reaches a minimum threshold. The method could also be implemented through a wireless communications network where a short messaging system can determine the parameters for recommending a service station.

### BACKGROUND OF THE INVENTION

This invention relates to a method and apparatus for an in vehicle low price fuel locator. More particularly, this disclosure relates to a method and apparatus for recommending fuel stations for an associated vehicle based on a users location, or a users route.

While the disclosure is particularly directed to the art of collecting and displaying gasoline prices, and will be thus described with specific reference thereto, it will be appreciated that this disclosure may have usefulness in other fields and applications. For example, the invention may be used in other types of mapping, including, but not limited to, alternative energy sources such as biodiesel, ethanol, hydrogen, methane, natural gas, wood, vegetable oil, etc.

By way of background, automotive navigational systems are becoming increasingly popular. These satellite navigational systems determine a user's location within a small area using time signals transmitted along a line of sight by radio from satellites. Receivers can then use this information in order to hone in on a users location. Tracking data can also be used in order to continuously update the position of a user, from which point a user is then capable of receiving directions from that specific location as the location is updated in real time.

The users can use global positioning systems (GPS) in order to receive directions for their destinations. Oftentimes, users will be on their way to a destination and need to stop in order to refuel. As gas prices tend to vary dramatically, even within a small area, it is often desirable for a driver to know the gas prices for stations that are nearby or within a certain amount of distance from the user's route. Furthermore, as new alternative fuel sources are being developed, it would be beneficial for the user to know which type of fuel a service station carries. Furthermore, in an emergency situation when evacuation may be necessary, it would be beneficial for a user to know which service stations are currently selling fuel and how far those service stations may be.

Therefore, there is a need in the industry to be able to communicate to a user which service stations are selling a particular type of fuel and at what price that service station is selling the fuel. Furthermore, there is a need in the industry to communicate to a user the location of that service station.

There is a further need in the industry to communicate to a user alternative fuel stations that may sell fuel at competitive prices that are also within the users proposed route.

The present invention contemplates a new and improved method and apparatus that resolves the above-referenced difficulties and others.

### SUMMARY OF THE INVENTION

A method and apparatus for recommending service stations for an associated vehicle based on a user's location is provided. The disclosure will communicate to a user which service stations are near by and which service stations are on the user's route. This information is coupled with the price and the type of fuel that the service station is selling. It can also be implemented via a vehicle navigation system which can recommend gas stations based on the amount of fuel remaining in the vehicle. Furthermore, the proposed disclosure can route which service stations a user should stop on throughout their trip in order to map the most cost effective route.

In one aspect of the disclosure, the method includes mapping a user's current location, collecting fuel prices from a first set of stations that are within a predetermined distance from the user's current location and displaying the location of at least one of the first set of stations based at least in part on fuel prices.

In accordance with another aspect of the present disclosure, the method further includes mapping a user's route, collecting fuel prices from a second set of stations that are within a predetermined distance from the user's route and displaying the location of at least one of the second set of stations based at least in part on fuel prices.

In accordance with another aspect of the present disclosure, the method further includes tracking the amount of fuel left in an associated vehicle and recommending stations at a time that is based at least in part on the amount of fuel remaining in the vehicle.

In accordance with yet another aspect of the present disclosure, the method further includes that fuel prices are collected from credit card transactions.

In accordance with yet another aspect of the present disclosure, the method further includes that the method is implemented via a vehicle navigation system.

In accordance with yet another aspect of the present disclosure, the method further includes it being implemented via a wireless communications network.

In accordance with yet another aspect of the present disclosure, the method further includes mapping a user's current location by a triangulation method.

In accordance with another aspect of the present disclosure, the method includes mapping the user's current location by iLocator.

In accordance with yet another aspect of the present disclosure, the method further includes using a short messaging system in order to set at least one parameter for the recommendation.

In accordance with another aspect of the present disclosure, a system includes a tracking module configured to locate the position of a user, a database configured to receive fuel information corresponding to at least one fuel station and a display that is in communication with the database and the tracking module wherein the display is configured to recommend at least one fuel station based at least in part on a) the distance between a fuel station and the user and b) the fuel information.

In accordance with another aspect of the present disclosure, the system comprises that fuel information includes the price of the fuel at the corresponding service station.

In accordance with another aspect of the present disclosure, the system comprises that the fuel information includes the type of fuel at the corresponding service station.

In accordance with another aspect of the present disclosure, the system comprises that the fuel information includes the brand name of the corresponding service station.

In accordance with another aspect of the present disclosure, the system comprises that the tracking module is part of a navigational system wherein the navigational system is configured to map a user's route.

In accordance with yet another aspect of the present disclosure, the system includes that the database receives at least part of the fuel information from credit card transactions.

In accordance with yet another aspect of the present disclosure, the system is configured to record the frequency in which the user requests fuel and recommends fuel stations based at least in part on that frequency.

In accordance with another aspect of the present disclosure, the method comprises receiving service station information from a plurality of service stations.

In accordance with another aspect of the present disclosure, the service station information includes the price of the fuel at the corresponding service station, mapping the location of a user, selecting at least one service station from the plurality of service stations based at least in part on the location of the service station and the location of the user and displaying the selected service station.

In yet another aspect of the present disclosure the method further includes mapping the route of the user and selecting at least one service station from the plurality of service stations based at least in part on the location of the fuel station and the route of the user.

In accordance with another aspect of the present disclosure, the method further includes that it is implemented via vehicle navigation system.

In accordance with yet another aspect of the present disclosure, the method further includes that it is implemented via a wireless communications network.

### DESCRIPTION OF THE DRAWINGS

The presently described embodiments exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the navigational network including a mobile switching center (MSC), a user's vehicle, at least one base station, a public network, and a service station.

FIG. 2 is an illustration of an expanded network including an MSC, a Milife® application server (MAS), a database server, at least one base station, a users vehicle and at least one service station.

FIG. 3 is a flow chart illustrating a method according to the present disclosure.

### DETAILED DESCRIPTION

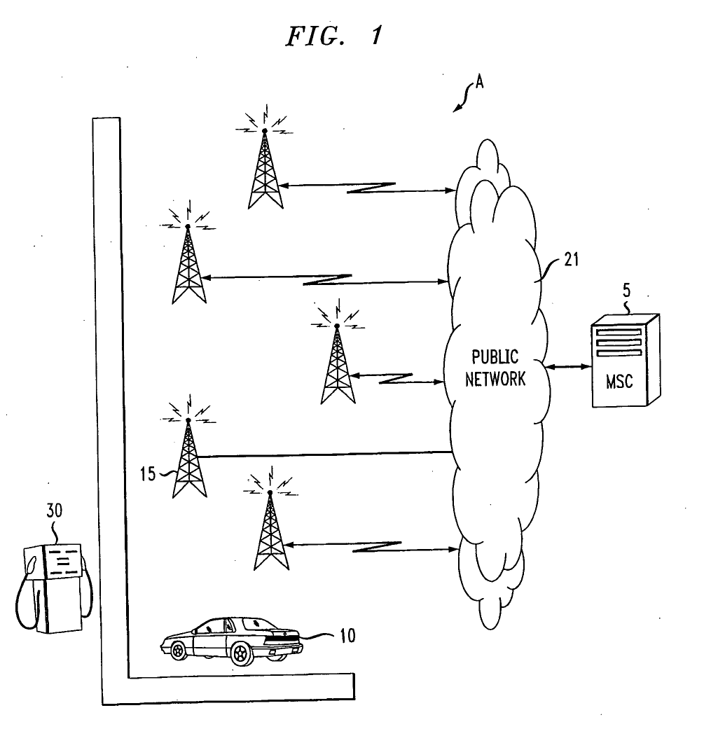

Referring now to the drawings wherein the showings are for purposes of illustrating the disclosed embodiments of the disclosure only and not for purposes of limiting the same. FIG. 1 provides a view of a system into which the present disclosure may be incorporated. A navigational infrastructure A is shown. The navigational infrastructure A includes an MSC 5, a user's vehicle 10, at least one base station 15, a public network 21 and a service station 30. It should be understood that this represents but one embodiment of the navigational infrastructure A. The present disclosure could be incorporated in a variety of navigational network configurations:

In operation, as described in greater detail below, the presently described embodiment includes a method and apparatus for recommending service stations for a vehicle based on the user's location.

Still referring to FIG. 1, as the user's vehicle 10 travels along a road, it can be located through the use of a base station 15. The base station can track the vehicle through a variety of different communication devices, including, but not limited to, wireless telephones, handsets, laptop computers, PDA, Wi-Fi phones, vehicle navigation systems, etc. Generally, the vehicle can be tracked via GPS, a triangulation method by iLocator or some other similar location based device.

The vehicle 10 will send the signal to the base station and the base station will communicate with the public network 21 through the MSC 5. An MSC 5 is a switch that is responsible for call handling and routing. An MSC 5 also acts as the interface to other switching elements including other switches.

The vehicle 10 will transmit a registration request and the MSC 5 will keep track of the vehicle's location in a database. In this form, a public network provider 21 will be able to track the vehicle's location. In this form, through the public network, as the vehicle travels along its path, it will stay in communication with a base station as it enters new cells and leaves old ones. This is done in order to ensure that a user is able to receive a call through the communication network or be tracked through a GPS network.

In one form the public network will also have a record of the service stations 30 which are located within a predetermined distance from the vehicle 10. The public network 21 will also be capable of receiving information about the service station 30, such as the service station's brand name, what type of fuel the service station is selling, the price of the fuel that the service station is selling, etc.

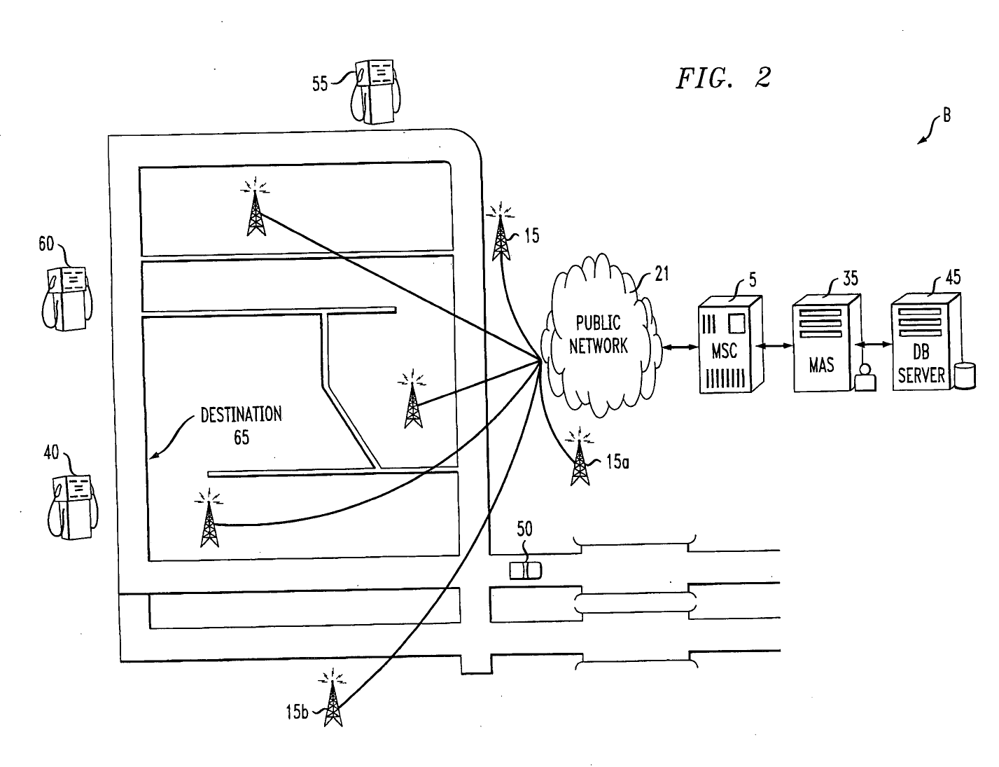

Now referring to FIG. 2, which is an expanded illustration of FIG. 1. This illustration also includes an MAS 35, a database server 45, and multiple service stations, 40, 55 and 60. The figure also includes a vehicle 50 and a destination for the vehicle 65. In this embodiment, the vehicle will travel along a path which will lead the vehicle to destination 65. As vehicle 50 travels, it can be tracked through the use of the MSC 5 and the plurality of base stations, 15, 15A and 15B.

FIG. 2 also discloses an MAS 35. The MAS is a server that offers a next generation converged service platform and an open interface programmable in media independent application. This can be useful in enabling concurrent service capabilities for the network. This network element can offer services such as iLocator, Sure Pay Solution, Sweet, Unified Subscriber Data Server, Intelligent Services Getaway, Presents, etc. These services, iLocator in particular, can enable precise tracking of vehicle 50. It should be recognized that other application servers may be substituted and still fit within the spirit of the claims.

FIG. 2 also shows a database server which may be used to store the location of service stations, along with the types of fuel that the service stations sell. The database server 45 can also be used in order to track credit card information, which would provide real time data indicating the price of the fuel that is being sold at the corresponding service station.

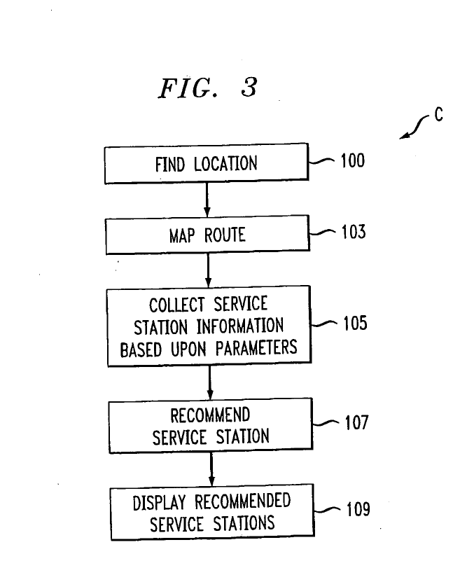

Referring to FIG. 3, a method of recommending service stations for a vehicle based on the user's route is illustrated. It should be understood that the method may be implemented by a variety of software and hardware configurations. In one embodiment, the software implementing method C resides in the service provider network, or in a variety of the service provider network elements. In another embodiment, software implementing method C resides in an MSC. In yet another embodiment, the software implementing method C resides on an MAS. In another embodiment, the software implementing method C resides in a vehicle navigation system, or mobile station. It should be understood that suitable software/hardware implementing the embodiments of this invention may also be distributed among a variety of network elements.

The method C includes finding the location of the user's vehicle (at step 100). This may be accomplished in a variety of manners known to those skilled in the art. This may include tracking the vehicle via a mobile station which is a part of a communications network. This tracking can be done by a triangulation method, iLocator, or any other manner known to those skilled in the art. Furthermore, the vehicles location could be found through GPS which is constantly tracking the vehicles location. Any variety of these methods may be used in order to track the location of the vehicle, as well as other methods known in the art.

Next, the method C continues with mapping the route for the vehicle (at step 103). In the embodiment shown in FIG. 2, the route for the vehicle is the route from the present location of the vehicle to the destination 65. This can also be accomplished using variety of methods known in the art.

Next, the method C includes collecting service station information based upon parameters (at step 105). Parameters may used in order to limit the number of service stations which will be surveyed. Parameters may be set by a variety of methods. If this method is implemented via a communications network which includes handsets and/or mobile stations, these parameters may be set by short messaging systems (SMS). In the SMS case, the user may input such information as the amount of distance that the user is willing to travel outside of his or her route in order to reach a service station. Other parameters could include limiting the brand of gas. For example, if the user has a credit card tied to a particular gas station that the user wants to use, that limit can be set to look for only that particular brand of gas. Furthermore, the user may own a vehicle that may only accept diesel gas, for example, in which case, only service stations that sell diesel gasoline will be displayed. In another embodiment, a user may be willing to travel further outside of the route in order to get a less expensive gasoline. In this case, the method may include a cost benefit analysis in which a station that may be far away in terms of distance may still be used if the gas is significantly less expensive than stations that are nearby. For example, referring to FIG. 2, if service station 55 is selling fuel at a significantly less expensive price than stations 60 or 40, method may recommend station 55, although it is not on the user's route. Many other parameters can also be set based on the user's preference.

The parameters may be stored in memory associated which any one or any combination of the network elements. For example, the parameter settings may be stored in the user's mobile station or in the user's vehicle navigation system. The parameters could also be stored in a MSC 5, a application server 35, a database server 45 or any combination thereof.

Once the system is in possession of the user's parameters, the parameters can then be parsed. Service stations that best fit the parameters then be gathered and surveyed for more information or displayed to the user.

The step continues with collecting the service stations information which may include the type of the fuel that the service station is selling, for example, biodiesel, ethanol, hydrogen, methane, natural gas, vegetable oil or any other type of fuel that the user's vehicle may accept, price of the fuel, brand name of the service station, etc. The collection of service station information may also include collecting the price of the fuel. In an emergency or shortage situation the service station information may simply include whether or not the station is currently selling fuel. Furthermore, the method allows for the collection of the service station information to be received from a variety of sources. In one embodiment, the method allows for the price of the fuel to be received through credit card transactions. In this form, the method would receive live feeds from credit card transactions taking place in real time, thereby identifying live, up to date fuel prices. In another embodiment, the method receives this information from the internet. In another embodiment, the method receives this information from the GPS satellite system. In this form, information could be received from other vehicles which have the same information and may share that information with the user's vehicle.

The method continues with recommending service stations. Once the information is received on the variety of service stations, the method continues with recommending a service station based at least in part on the information received on the set of service stations. This method could include recommending one or more service stations which meet the parameters in order to give the user the best gas according to that user's criteria. This could mean the gas that is sold at the cheapest price or it could mean the gas that is within the user's route sold at the cheapest price. It could also mean the service station which has alternative fuel sources. In the alternative, it could mean the service station with a particular brand name. In any form the method will display the recommended service stations (at step 109) which the method recommended at step 107.

The system may integrate all of the information including the service station information and the parameters set by the user in order to recommend one or more service stations. Once the user chooses a station, the system may store that information and use it in order to reevaluate its recommendation for the next time the system is implemented. In this form, the system may “learn” which type of service stations that the user prefers. In addition, the system may be able to evaluate which parameters are most important to the user.

The above description merely provides a disclosure of a particular embodiment of the invention and is not intended for the purposes of limiting the same thereto. As such, the disclosure is not limited to only the above-described embodiments. Rather, it is recognized that one skilled in the art could conceive alternative embodiments that fall within the scope of the invention.

We claim:

1. A method for recommending service stations for an associated vehicle based on a users location comprising:
mapping a user's current location;
collecting service station information from a first set of service stations that are within a predetermined distance from said users current location; and
displaying the location of at least one of said first set service stations based at least in part on said service station information.

2. The method according claim 1, further comprising:
mapping a users route;
collecting service station information from a second set of service stations that are within a predetermined distance from said users route; and
displaying the location of at least one of said second set of service stations based at least in part on said service station information.

3. The method according to claim 1, further comprising:
tracking the amount of fuel left in said associated vehicle; and
recommending service stations at a time that is based at least in part on the amount of fuel remaining in said associated vehicle.

4. The method according to claim 1 wherein said service station information is collected from credit card transactions.

5. The method according to claim 1 wherein said method is implemented via a vehicle navigation system.

6. The method according to claim 1 wherein said method is implemented via a wireless communications network.

7. The method according to claim 6 wherein said mapping of a user's current location is done by a triangulation method.

8. The method according to claim 6 wherein said mapping of a user's current location is done by iLocator.

9. The method according to claim 6, further including using a short messaging system in order to set at least one parameter for said recommendations.

10. A system for recommending service stations for an associated vehicle based on said users location comprising:
a tracking module configured to locate the position of a user;
a database configured to receive fuel information corresponding to at least one service station;
a display that is in communication with said database and said tracking module, said display is configured to recommend at least one service station based at least in part on a) the distance between the service station and the user and b) said fuel information.

11. A system according to claim 10 wherein said fuel information includes the price of the fuel at the corresponding service station.

12. A system according to claim 10 wherein said fuel information includes the type of the fuel at the corresponding service station.

13. A system according to claim 10 wherein said fuel information includes the brand name of the corresponding service station.

14. A system according to claim 10 wherein said tracking module is part of a navigational system, said navigational system is configured map a users route.

15. A system according to claim 10 wherein said database receives at least part of said fuel information from credit card transactions.

16. A system according to claim 10 wherein said system is configured to record the frequency in which a user requests fuel and recommend service stations based at least in part on said frequency.

17. A method comprising:
receiving service station information from a plurality of service stations, said service station information including the price of the fuel at said plurality of service station;
mapping the location of a user;
selecting at least one service station from said plurality of service stations based at least in part on the location of said service station and the location of the user; and
displaying said selected service stations.

18. The method according to claim further comprising:
mapping the route of the user; and
selecting at least one service station from said plurality of service stations based at least in part on the location of said service station and the route of the user.

19. The method according to claim 1 wherein said method is implemented via a vehicle navigation system.

20. The method according to claim 1 wherein said method is implemented via a wireless communications network.
